(19) United States
(12) Patent Application Publication
(10) Pub. No.: US 2016/0358677 A1
(43) Pub. Date: Dec. 8, 2016

(54) Control Rod Drive Mechanism

(71) Applicant: Hitachi-GE Nuclear Energy, Ltd., Hitachi-shi (JP)

(72) Inventors: Yasuhiko FURUTA, Hitachi-shi (JP); Hirokazu AKATSUKA, Hitachi-shi (JP); Toshihiro KODAMA, Hitachi-shi (JP)

(21) Appl. No.: 15/165,143

(22) Filed: May 26, 2016

(30) Foreign Application Priority Data
Jun. 5, 2015 (JP) 2015-115099

(51) Int. Cl. G21C 7/16

(52) U.S. Cl. CPC G21C 7/16; G21Y 2002/104; G21Y 2004/302

(57) ABSTRACT

A control rod drive mechanism (CRD) capable of more securely preventing outflow of water when a scram piping is broken is provided. In a CRD, a ball check valve is provided in a flange provided in a lower end portion of an outer tube. The ball check valve includes a ball, a retainer, and a ball support mechanism, and the retainer has a valve flow channel. The ball support mechanism for supporting the ball is provided in a lower opening portion. A height of an upper end of the ball support mechanism is set so as not to bring the ball into contact with an upper corner portion of the lower opening portion.

### TECHNICAL FIELD

The present invention relates to a control rod drive mechanism (hereinafter, also referred to as CRD (Control Rod Drive)) used in a boiling water reactor (hereinafter, also referred to as BWR) serving as a light-water reactor.

### BACKGROUND ART

As an exemplary control rod drive mechanism of a boiling water reactor including a check valve that securely operates when an inserted piping is broken, PTL 1 discloses a control rod drive mechanism in which a flange is fixed to a lower portion of a control rod drive mechanism housing and a check valve is provided in an inserted flow channel formed in the flange so as to prevent outflow of reactor water when the inserted piping is broken by using this check valve, in which a valve body of the check valve is supported by a coil spring made of shape-memory alloy, this coil spring made of shape-memory alloy maintains a compressed state at 40° C. to 60° C. and maintains a stretched state at 80° C. or above, and, when the coil spring is stretched, the valve body receives a spring action of the coil spring to block a connection-side opening of the inserted piping.

### CITATION LIST

### Patent Literature

PTL 1: JP-A-62-132196

### SUMMARY OF INVENTION

### Technical Problems

In a BWR, a control rod drive mechanism is provided in a control rod drive mechanism housing (hereinafter, referred to as a CRD housing) provided in a bottom portion of a reactor pressure vessel (hereinafter, referred to as RPV). The CRD puts a control rod in and out of a reactor core arranged in the RPV.

The CRD includes an outer tube, and a guide tube is provided in this outer tube. A ball nut and a hollow piston attached to this ball nut and extending upward are arranged in the guide tube. An upper end portion of the hollow piston is connected to the control rod. A ball spindle arranged in the hollow piston is engaged with the ball nut. The ball spindle is rotated by a motor. Rotation of the ball spindle moves the ball nut upward and downward, thereby moving the hollow piston upward and downward. With this, the control rod is put in and out of the reactor core to control reactor power.

A flange provided in a lower end portion of the outer tube is attached to the CRD housing, and the CRD is held by the RPV. A ball check valve is provided in the flange provided in the lower end portion of this outer tube. A scram piping is attached to the CRD housing and is connected to a flow channel (referred to as a valve flow channel) of the ball check valve in the flange. This valve flow channel communicates to the inside of the outer tube via a central flow channel and a lower flow channel.

At the time of normal operation, purge water supplied from the scram piping passes through the central flow channel via the ball check valve to be introduced into the outer tube. At this time, a ball of the ball check valve is pressed to a whole circumference of a corner portion of an opening portion of the lower flow channel (hereinafter, referred to as a lower seating surface), and therefore the purge water does not flow into the lower flow channel.

At the time of emergency insertion of a control rod (at the time of a scram), high-pressure water from an accumulator flows into the flow channel in the flange via the scram piping to be supplied to the outer tube via the central flow channel. The high-pressure water supplied to the outer tube rapidly moves the hollow piston upward. The control rod connected to the hollow piston is rapidly inserted into the reactor core, and the reactor is scrammed. Also at this time, the ball of the ball check valve is pressed to the lower seating surface.

In the case where the scram piping is broken, water in the outer tube flows through a broken opening of the scram piping via the central flow channel. This may cause a pressure applied to the hollow piston from below in the outer tube to be lower than a pressure applied to the hollow piston from above therein, thereby pressing the hollow piston downward, and therefore the control rod may be pulled out from the reactor core. However, a pressure in a portion above the ball is reduced to be lower than a pressure in a portion below the ball, and therefore the ball of the ball check valve is pressed upward. The ball is pressed from below to a corner portion of an upper opening portion (hereinafter, referred to as an upper seating surface) of the valve flow channel communicating to the scram piping, thereby preventing outflow of water through the broken opening of the scram piping.

The case where the ball pressed to the lower seating surface at the time of normal operation and at the time of emergency insertion of the control rod is adhered to the seating surface by any chance is assumed. In this state, the ball is not pressed to the upper seating surface when the scram piping is broken, and therefore outflow of water through the broken opening of the scram piping cannot be prevented.

Further, the stretched state is maintained at 80° C. or above in the technique disclosed in PTL 1, and therefore only the case where high temperature water flows, i.e., an embodiment in which a spring action is exerted when the scram piping is broken is assumed. At the time of normal operation or at the time of a scram in this case, the coil spring keeps a compressed state, that is, the spring and the ball do not brought into contact with each other and the ball is held in a state of being in contact with the lower seating surface. In this case, a contact point between the ball and the lower seating surface is always the same, and the ball is in a state of being adhered to the lower seating surface. Thus, when the scram piping is broken, adhesion between the ball and the lower seating surface is not canceled depending on the degree of adhesion even in the case where the coil spring acts, and therefore the ball does not operate, which cannot prevent outflow of water from the scram piping in some cases.

An object of the invention is to provide a control rod drive mechanism capable of more securely preventing outflow of water when a scram piping is broken.

### Solution to Problem(s)

In order to solve the above problems, for example, features recited in Claims are employed.

The invention includes a plurality of means to solve the above problems, and an example thereof includes: a housing having a flange in a lower end portion; a piston device for moving a control rod upward with a water pressure, the piston device being arranged in the housing; a water introduction path for introducing high-pressure water to apply the water pressure to the piston device, the water introduction path being provided in the housing; a ball check valve provided in the housing, communicating to an opening portion of the water introduction path, and including a ball for blocking the opening portion of the water introduction path when water in the housing flows backward to the water introduction path; a central flow channel for introducing the high-pressure water into the housing, the central flow channel having an opening portion opened toward the ball check valve; a lower flow channel having a lower opening portion opened toward the ball check valve at a position lower than a position of the opening portion of the central flow channel, the lower flow channel being a flow channel via which the water in the housing for pushing up the ball flows at the time of the backward flow; and a drive-type ball support mechanism for supporting the ball, the drive-type ball support mechanism being provided in the flange, having a gap between the ball and a structural member forming the lower opening portion at the time of normal operation, and being deformed to change a contact state between the ball and the lower opening portion at the time of injection of high-pressure water.

### Advantageous Effects of Invention

According to the invention, a risk of adhesion of a ball of a ball check valve to a lower seating surface can be reduced as compared with conventional arts, and outflow of water can be prevented more securely when a scram piping is broken, as compared with conventional arts.

### BRIEF DESCRIPTION OF DRAWINGS

FIG. 1 is a longitudinal cross-sectional view of a control rod drive mechanism in Example 1 which is a preferred example of the invention.

FIG. 2 is an enlarged view of a ball check valve illustrated in FIG. 1 (at the time of normal operation).

FIG. 3 is an enlarged view of the ball check valve illustrated in FIG. 1 (at the time of injection of high-pressure water).

FIG. 4 is an enlarged view of a ball check valve of a control rod drive mechanism in Example 2 of the invention.

FIG. 5 is an enlarged view of a ball check valve of a control rod drive mechanism in Example 3 of the invention.

FIG. 6 is an enlarged view of a ball check valve of a control rod drive mechanism in Example 4 of the invention (at the time of injection of purge water).

FIG. 7 is an enlarged view of the ball check valve illustrated in FIG. 6 (at the time of injection of high-pressure water).

FIG. 8 is an enlarged view of a ball check valve of a control rod drive mechanism in Example 5 of the invention (at the time of injection of purge water).

FIG. 9 is an enlarged view of the ball check valve illustrated in FIG. 8 (at the time of injection of high-pressure water).

FIG. 10 is an enlarged view of a ball check valve of a control rod drive mechanism in Example 6 of the invention (at the time of injection of purge water).

FIG. 11 is an enlarged view of the ball check valve illustrated in FIG. 10 (at the time of injection of high-pressure water).

FIG. 12 is an enlarged view of a ball check valve of a control rod drive mechanism in Example 7 of the invention (at the time of injection of purge water).

FIG. 13 is an enlarged view of the ball check valve illustrated in FIG. 12 (at the time of injection of high-pressure water).

FIG. 14 is an enlarged view of a ball check valve of a control rod drive mechanism in Example 8 of the invention (at the time of injection of purge water).

FIG. 15 is an enlarged view of the ball check valve illustrated in FIG. 14 (at the time of injection of high-pressure water).

### DESCRIPTION OF EMBODIMENTS

Hereinafter, examples of a control rod drive mechanism of the invention will be described with reference to the drawings.

### Example 1

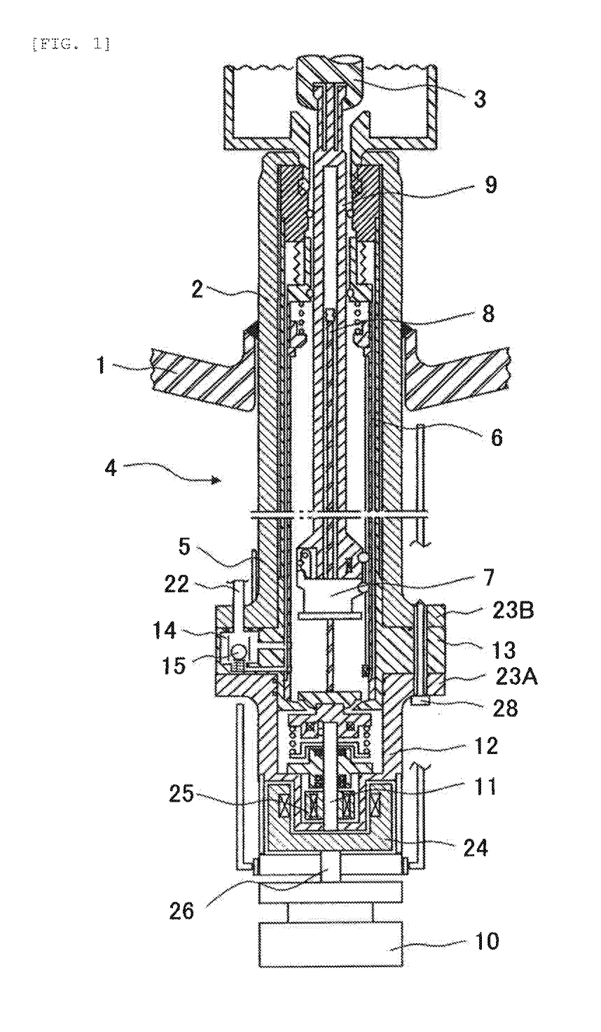

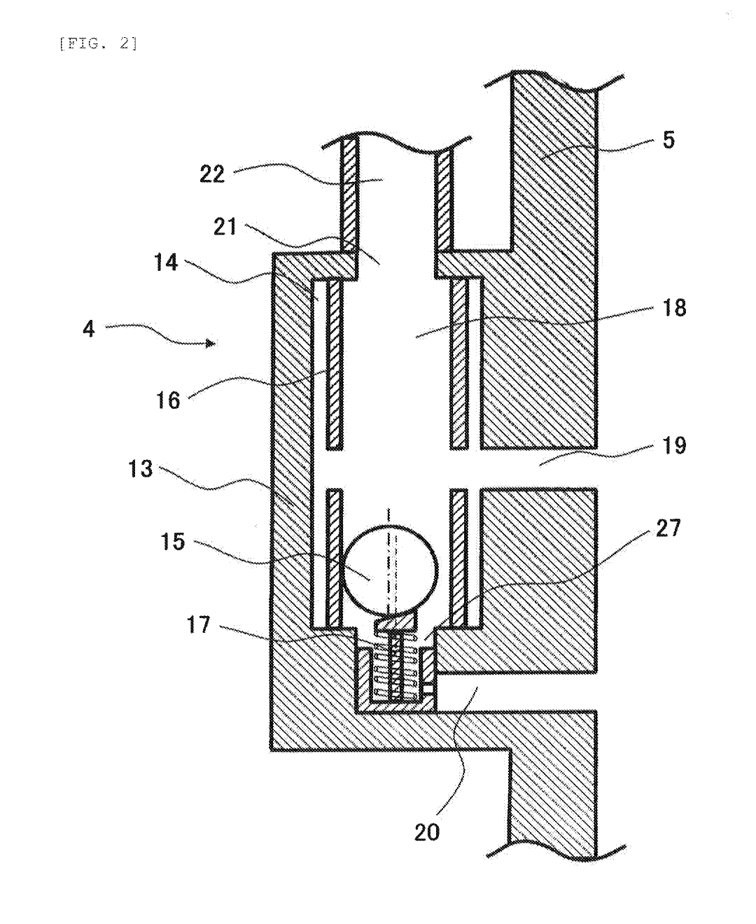

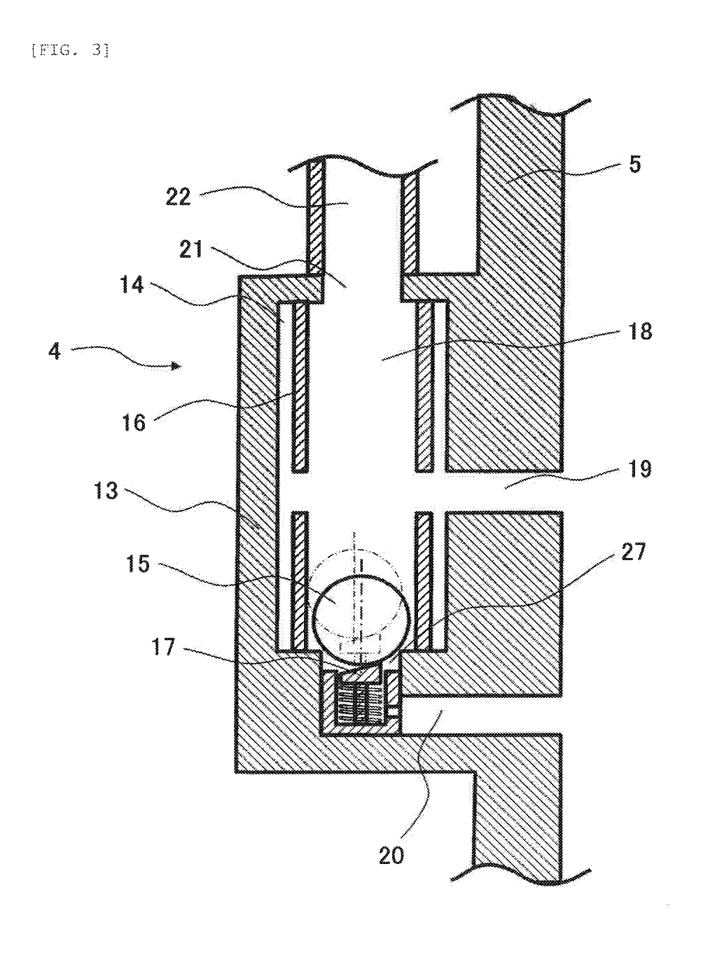

A control rod drive mechanism (CRD) in Example 1 which is a preferred example of the invention will be described with reference to FIG. 1 to FIG. 3. Note that, in FIG. 1 to FIG. 3, an example where the CRD is applied to a BWR as a reactor will be described. FIG. 1 is a longitudinal cross-sectional view of the control rod drive mechanism in Example 1 which is the preferred example of the invention. FIG. 2 is an enlarged view of a ball check valve illustrated in FIG. 1 (at the time of normal operation). FIG. 3 is an enlarged view of the ball check valve illustrated in FIG. 1 (at the time of injection of high-pressure water).

In FIG. 1, a CRD 4 in this example is applied to a boiling water reactor (BWR) and includes an outer tube 5, a guide tube 6, a ball nut 7, a ball spindle 8, a hollow piston 9, a motor unit 10, a flange 13, and a ball check valve 14.

The CRD 4 is attached to a CRD housing 2 provided in a bottom portion of a RPV 1 of the BWR. The CRD housing 2 penetrates the bottom portion of the RPV 1 and extends downward to be lower than the bottom portion. The outer tube 5 is arranged in the CRD housing 2. The flange 13 provided in a lower end of the outer tube 5 is arranged between a flange 23A of a spool piece 12 and a flange 23B provided in a lower end portion of the CRD housing 2. Those three flanges 23B, 13, and 23A are joined by a bolt 28. With this, the outer tube 5 is attached to the CRD housing 2.

The guide tube 6 is arranged in the outer tube 5. The ball nut 7, the ball spindle 8, and the hollow piston 9 are arranged in the guide tube 6. The ball nut 7 is engaged with the ball spindle 8 extending in an axial direction of the outer tube 5. The hollow piston 9 is placed on an upper surface of the ball nut 7. The ball spindle 8 is inserted into an elongated hole portion formed in the hollow piston 9. An upper end portion of the hollow piston 9 reaches the inside of the RPV 1 and is detachably connected to a control rod 3. The motor unit 10 is attached to the spool piece 12, and an outer electromagnetic coupling 24 linked to the motor unit 10 by a rotary shaft 26 is arranged outside the spool piece 12. An inner electromagnetic coupling 25 is arranged inside the spool piece 12 and faces to the outer electromagnetic coupling 24 via the spool piece 12. A rotary shaft 11 is linked to the inner electromagnetic coupling 25.

The ball check valve 14 is provided in the flange 13. A detailed configuration of this ball check valve 14 will be described with reference to FIG. 2 and FIG. 3.

As illustrated in FIG. 2 and FIG. 3, the ball check valve 14 includes a solid ball 15 made of metal, a tubular retainer (tubular body) 16 having a plurality of through holes on a side wall thereof, and a drive-type ball support mechanism 17 including a coil spring. The ball check valve 14 uses the flange 13 as a casing and has a valve flow channel 18 formed in the flange 13. The valve flow channel 18 communicates to a scram piping 22 via a water introduction path 21 formed in the flange 13 and communicates to the inside of the outer tube 5 via a central flow channel 19. An opening portion of the water introduction path 21 is opened toward the valve flow channel 18, and an opening portion of the central flow channel 19 is also opened toward the valve flow channel 18. A lower flow channel 20 communicating to the inside of the outer tube 5 communicates to a portion below the ball 15 via a lower opening portion 27 and the ball support mechanism 17.

The ball support mechanism 17 supporting the ball 15 is provided in the lower opening portion 27. As illustrated in FIG. 2, a height of an upper end of the ball support mechanism 17 is set so as not to bring the ball into contact with an upper corner portion of the lower opening portion 27. The ball 15 is arranged in the retainer 16. The coil spring of the ball support mechanism 17 is a spring whose spring constant is set so that the spring keeps a stretched state at the time of normal operation and when the scram piping 22 is broken and keeps a compressed state at the time of injection of high-pressure water.

Reactor power is increased at the time of, for example, start of the reactor including the CRD 4 illustrated in FIG. 2 and FIG. 3 by pulling out the control rod 3 from the reactor core in the RPV 1. The control rod is pulled out by rotating the motor unit 10. Rotational force of the motor unit 10 is transmitted to the rotary shaft 26 and the outer electromagnetic coupling 24. Rotation of the outer electromagnetic coupling 24 rotates the inner electromagnetic coupling 25, thereby, for example, rotating the rotary shaft 11 and the ball spindle 8 forward. Forward rotation of the ball spindle 8 moves the ball nut 7 downward. Rotary motion of the ball nut 7 is limited by a guide rail which is formed on an inner surface of the guide tube 6, and extending in the axial direction, whereas movement thereof in an axial direction of the guide tube 6 is allowed. The control rod 3 is pulled out from the reactor core in accordance with downward movement of the ball nut 7, and the reactor power is increased. In order to reduce the reactor power, reverse rotation of the motor unit 10 reversely rotates the ball spindle 8, thereby moving the ball nut 7 upward.

Herein, at the time of normal operation of the BWR, purge water from a condensate storage tank (not illustrated) flows into the valve flow channel 18 through the scram piping 22 via the water introduction path 21. This purge water is supplied to the outer tube 5 via the central flow channel 19. The ball 15 is pressed to the upper end of the ball support mechanism 17 due to a flow of the purge water falling in the valve flow channel 18. However, the ball support mechanism 17 is designed not to be compressed by a pressure of the purge water, and therefore the lower opening portion 27 is not blocked by the ball 15. The purge water that has flowed into the valve flow channel 18 partially flows into the lower flow channel 20 via the lower opening portion 27 to be introduced into the outer tube 5.

When the necessity for emergency shutdown of the reactor arises due to earthquake or the like, high-pressure water in an accumulator (not illustrated) is supplied to the valve flow channel 18 via the scram piping 22. As illustrated in FIG. 3, the high-pressure water compresses the coil spring of the ball support mechanism 17 to cause the ball 15 to block the lower opening portion 27 and therefore the high-pressure water is supplied to the outer tube 5 via the central flow channel 19. By such action of the high-pressure water, the hollow piston 9 placed on the upper surface of the ball nut 7 is apart from the ball nut 7 to rapidly move upward, which results in emergency insertion of the control rod 3 into the reactor core. The reactor is scrammed. The motor unit 10 is driven at the same time as the high-pressure water is supplied to the valve flow channel 18 and moves the ball nut 7 upward until the upper surface of the ball nut 7 is brought into contact with a lower end surface of the hollow piston 9. Thereafter, the hollow piston 9 is supported by the ball nut 7. Note that a phenomenon in which own weight of the control rod 3 is applied to the ball nut 7 via the hollow piston 9 and the ball spindle 8 rotates to move the control rod 3 downward never occurs because rotation of the ball spindle 8 is prevented by an electromagnetic brake in the hollow piston 9 in a state in which the control rod 3 is held at a predetermined position in an axial direction of the reactor core.

In the case where the scram piping 22 is broken by any chance, a pressure in the valve flow channel 18, i.e., a pressure in a portion above the ball 15 is rapidly reduced. Therefore, the high-pressure water in the outer tube 5 flows backward into the valve flow channel 18 via the central flow channel 19 to flow into the outside of the scram piping 22 through a broken portion of the scram piping 22. Herein, the pressure in the portion above the ball 15 is reduced to be lower than a pressure in the portion below the ball 15 in the valve flow channel 18, and therefore the ball 15 moves upward. The high-pressure water in the outer tube 5 flows into the portion below the ball 15 via the lower flow channel 20, and therefore the ball 15 rapidly moves upward to block the opening portion of the water introduction path 21. As a result, it is possible to prevent outflow of the water in the outer tube 5 through this broken opening of the scram piping 22.

An effect of this example will be described.

As described above, in the CRD in this example, the ball 15 is brought into contact with the upper end of the ball support mechanism 17 also when purge water is supplied to the valve flow channel 18 at the time of normal operation of the BWR, and therefore it is possible to prevent the ball 15 from seating on an upper corner portion of a structural member (structural member of the flange 13) existing around the lower opening portion 27 (hereinafter, referred to as an upper corner portion of the lower opening portion 27). That is, the ball 15 is brought into contact with an upper end surface of the ball support mechanism 17 having a small contact area, and therefore the ball 15 and the upper corner portion of the structural member have a gap. This suppresses adhesion between the ball 15 and the upper corner portion. At the time of injection of high-pressure water, the ball support mechanism 17 is driven so that the coil spring is in a compressed state, and therefore a contact state between the ball 15 and an upper portion of the ball support mechanism 17 is changed. This makes it possible to reduce a risk of adhesion between the ball 15 and the upper portion of the ball support mechanism 17. Thus, even in the case where the scram piping 22 is broken by any chance, the ball 15 can quickly move upward and the opening portion of the water introduction path 21 can be blocked by the ball 15. This makes it possible to further improve safety.

When the upper end portion of the ball support mechanism 17 has an inclined surface or a curved surface as illustrated in FIG. 2 and FIG. 3, a position of a central axis of the ball 15 is changed between when purge water is injected and when high-pressure water is supplied and the spring is compressed. This makes it possible to change more efficiently a portion where the ball 15 is brought into contact with the ball support mechanism 17 and to reduce more effectively the risk of adhesion between the ball 15 and the upper portion of the ball support mechanism 17.

Note that the CRD 4 in the above example has a structure in which the spool piece 12 is provided to divide a rotary shaft for transmitting rotational force of the motor unit 10 to the ball spindle 8 so as to improve airtightness between the inside of the outer tube 5 and the outside thereof. However, a configuration of the ball check valve 14 and the ball support mechanism 17 applied to the CRD 4 is also applicable to a CRD having a structure in which a single rotary shaft for transmitting the rotational force of the motor unit 10 to the ball spindle 8 is provided and this rotary shaft is sealed with a shaft seal structure.

### Example 2

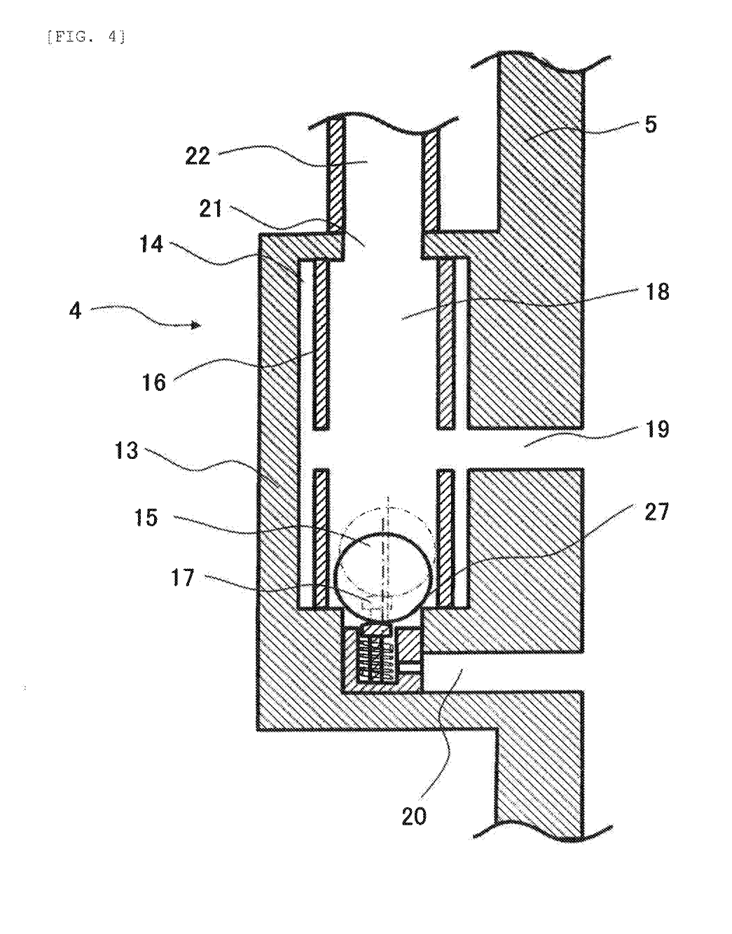

Example 2 of the control rod drive mechanism in the invention will be described with reference to FIG. 4. The same configurations as the configurations in FIG. 1 to FIG. 3 are denoted by the same reference signs, and description thereof is omitted. The same applies to the following examples. FIG. 4 is an enlarged view of a ball check valve of the control rod drive mechanism in Example 2 of the invention.

As illustrated in FIG. 4, the control rod drive mechanism in this example has a configuration in which the ball support mechanism 17 is arranged at a position decentering from the center of the lower opening portion 27, instead of having the configuration in which the upper end portion of the ball support mechanism 17 has an inclined surface or a curved surface as in the CRD in Example 1. With this configuration, the position of the central axis of the ball 15 is changed between when purge water is injected and when high-pressure water is supplied and the spring is compressed, thereby changing the portion where the ball 15 is brought into contact with the ball support mechanism 17.

Note that the configuration other than the above configuration is substantially the same as that of the control rod drive mechanism in Example 1 described above, and therefore detailed description thereof is omitted.

Also in Example 2 of the control rod drive mechanism in the invention, it is possible to obtain an effect of reduction in the risk of adhesion between the ball 15 and the upper portion of the ball support mechanism 17, which is substantially the same effect as that of Example 1 of the control rod drive mechanism described above.

Because the ball support mechanism 17 is arranged at a position decentering from the center of the lower opening portion 27, the position of the ball 15 is changed between when purge water is injected and when high-pressure water is injected. This can suppress adhesion more securely.

### Example 3

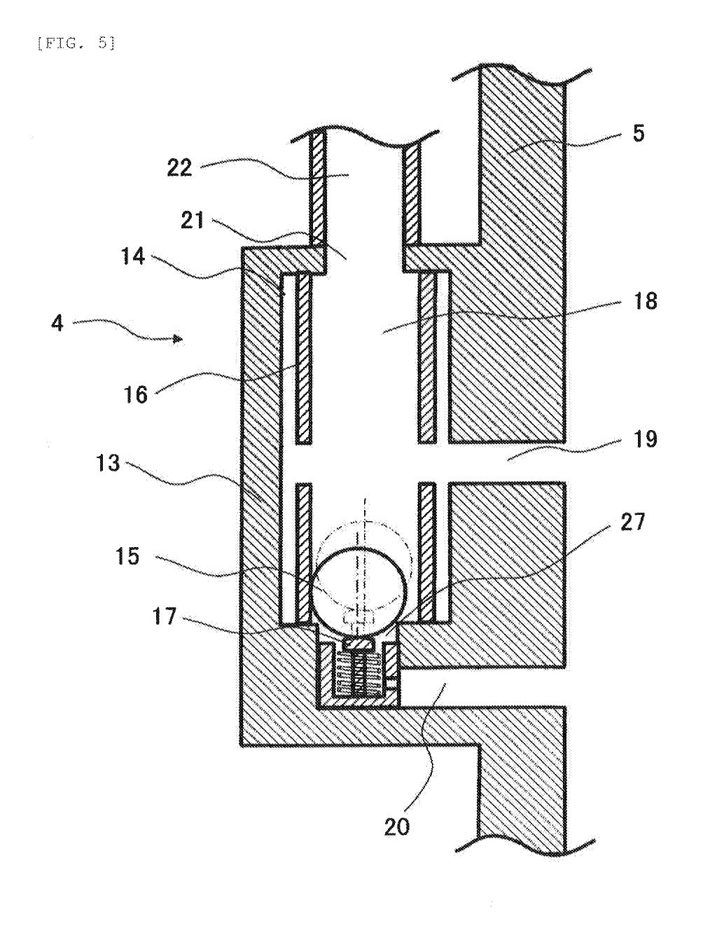

Example 3 of the control rod drive mechanism in the invention will be described with reference to FIG. 5. FIG. 5 is an enlarged view of a ball check valve of the control rod drive mechanism in Example 3 of the invention.

As illustrated in FIG. 5, the control rod drive mechanism in this example has a configuration in which the center of the lower opening portion 27 is provided at a position decentering from the center of the retainer 16, instead of having the configuration in which the upper end portion of the ball support mechanism 17 has an inclined surface or a curved surface as in the CRD in Example 1. With this configuration, the position of the central axis of the ball 15 is changed between when purge water is injected and when high-pressure water is supplied and the spring is compressed, thereby changing the portion where the ball 15 is brought into contact with the ball support mechanism 17.

Note that the configuration other than the above configuration is substantially the same as that of the control rod drive mechanism in Example 1 described above, and therefore detailed description thereof is omitted.

Also in Example 3 of the control rod drive mechanism in the invention, it is possible to obtain substantially the same effect as that of Example 1 of the control rod drive mechanism described above.

Also when the center of the lower opening portion 27 is provided at a position decentering from the center of the retainer 16, the position of the ball 15 is changed between when purge water is injected and when high-pressure water is injected. This can suppress adhesion more securely.

### Example 4

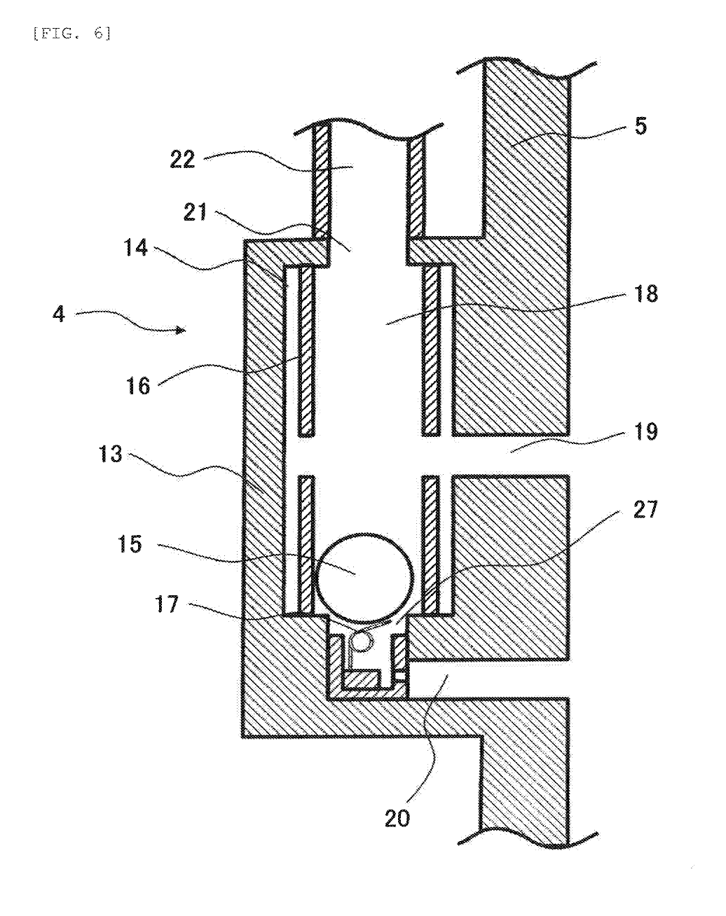

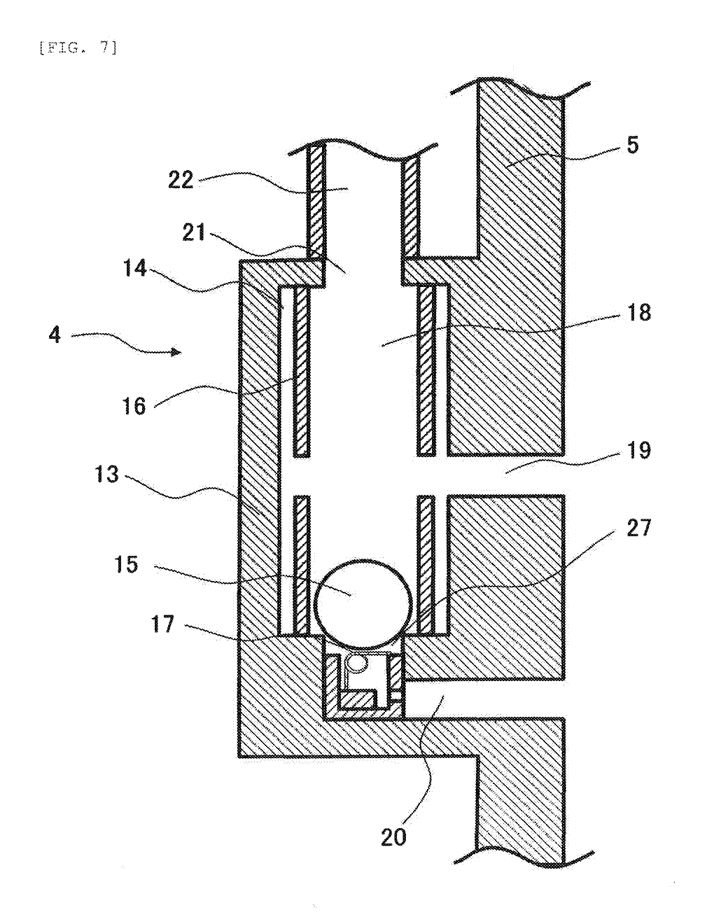

Example 4 of the control rod drive mechanism in the invention will be described with reference to FIG. 6 and FIG. 7. FIG. 6 is an enlarged view of a ball check valve of the control rod drive mechanism in Example 4 of the invention (at the time of injection of purge water). FIG. 7 is an enlarged view of the ball check valve illustrated in FIG. 6 (at the time of injection of high-pressure water).

As illustrated in FIG. 6 and FIG. 7, the control rod drive mechanism in this example has a configuration using a torsion spring as the ball support mechanism 17 instead of using the coil spring of the ball support mechanism 17 as in the CRD in Example 1. The control rod drive mechanism in this example is also applied to the BWR.

Note that the configuration other than the above configuration is substantially the same as that of the control rod drive mechanism in Example 1 described above, and therefore detailed description thereof is omitted.

Also in the CRD in this example, the torsion spring used as the ball support mechanism 17 changes the portion where the ball 15 is brought into contact with the ball support mechanism 17 when high-pressure water is supplied and the spring is compressed. This makes it possible to reduce the risk of adhesion between the ball 15 and the upper portion of the ball support mechanism 17.

Because the torsion spring is used as the ball support mechanism 17, the risk of adhesion between the ball 15 and the upper portion of the ball support mechanism 17 can be reduced with a simple configuration.

### Example 5

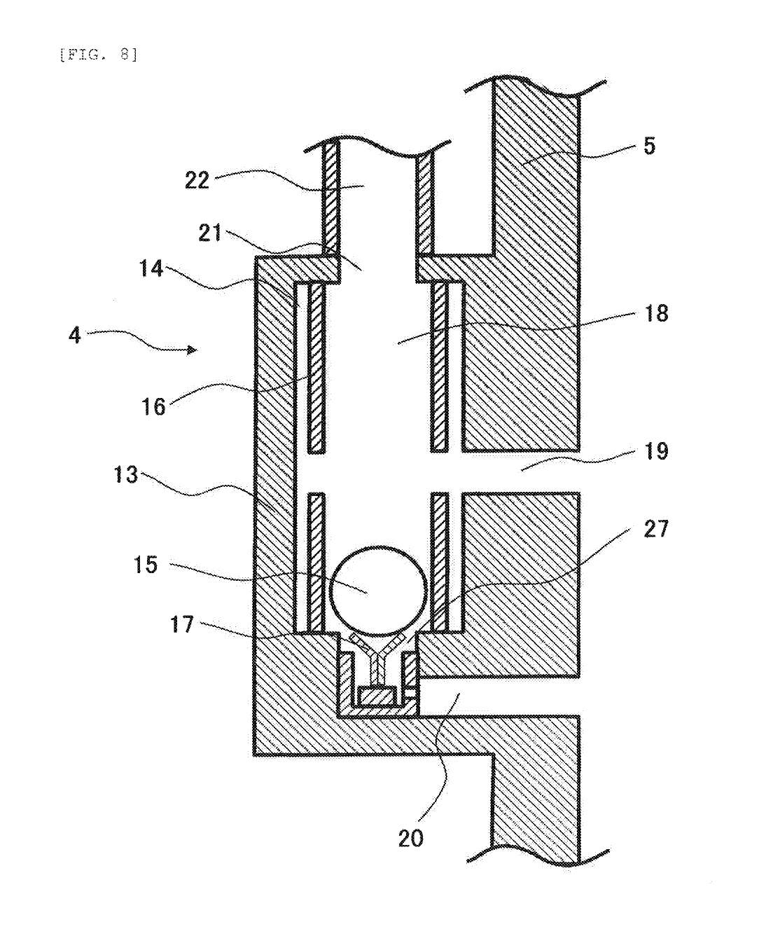

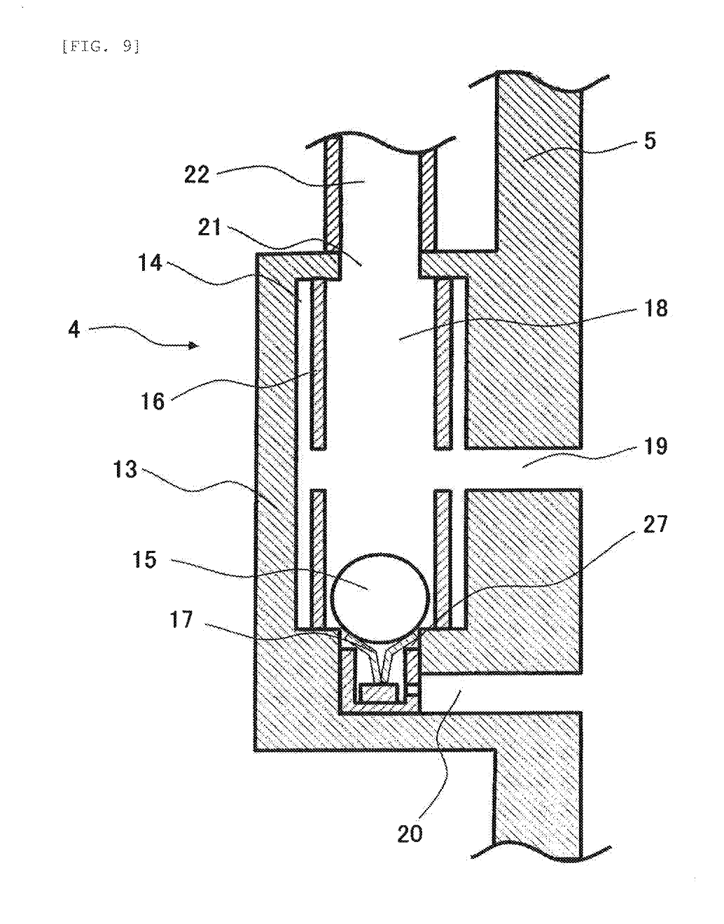

Example 5 of the control rod drive mechanism in the invention will be described with reference to FIG. 8 and FIG. 9. FIG. 8 is an enlarged view of a ball check valve of the control rod drive mechanism in Example 5 of the invention (at the time of injection of purge water). FIG. 9 is an enlarged view of the ball check valve illustrated in FIG. 8 (at the time of injection of high-pressure water).

As illustrated in FIG. 8 and FIG. 9, the control rod drive mechanism in this example has a configuration using a plate spring as the ball support mechanism 17 instead of using the coil spring of the ball support mechanism 17 as in the CRD in Example 1. The control rod drive mechanism in this example is also applied to the BWR.

Note that the configuration other than the above configuration is substantially the same as that of the control rod drive mechanism in Example 1 described above, and therefore detailed description thereof is omitted.

Also in the CRD in this example, the plate spring used as the ball support mechanism 17 can change the portion where the ball 15 is brought into contact with the ball support mechanism 17 when high-pressure water is supplied and the spring is compressed. This makes it possible to reduce the risk of adhesion between the ball 15 and the upper portion of the ball support mechanism 17.

Because the plate spring is used as the ball support mechanism 17, the risk of adhesion between the ball 15 and the upper portion of the ball support mechanism 17 can be reduced with a simple configuration.

### Example 6

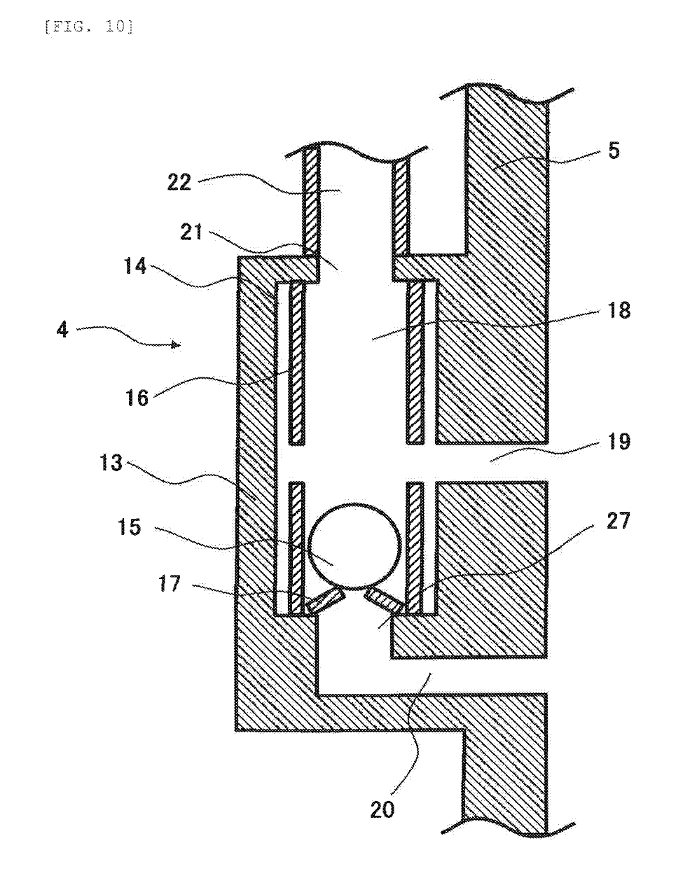

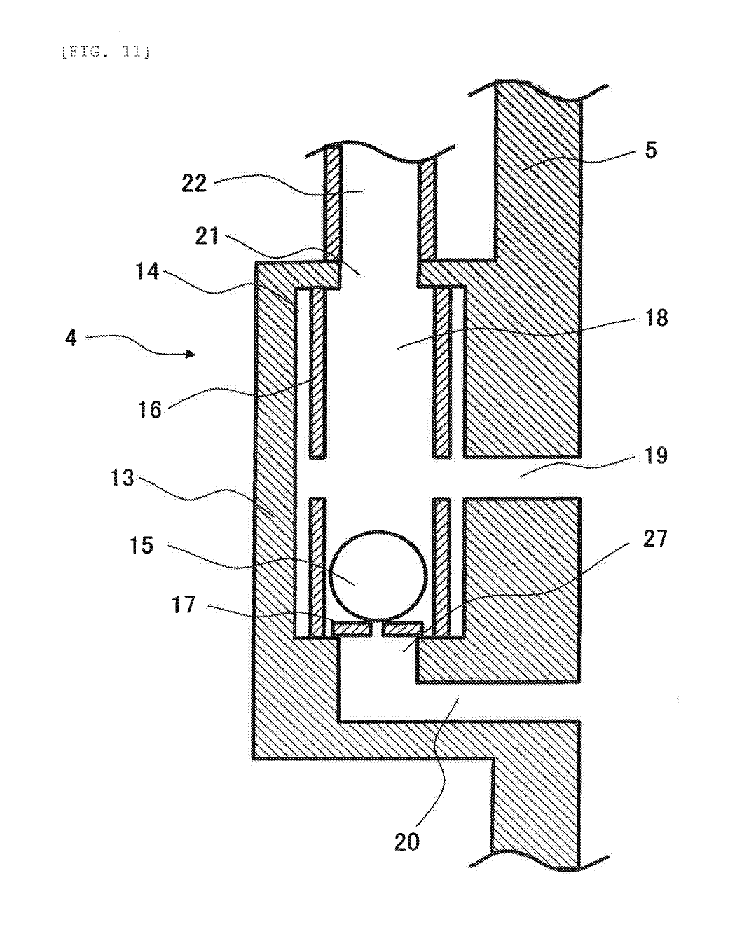

Example 6 of the control rod drive mechanism in the invention will be described with reference to FIG. 10 and FIG. 11. FIG. 10 is an enlarged view of a ball check valve of the control rod drive mechanism in Example 6 of the invention (at the time of injection of purge water). FIG. 11 is an enlarged view of the ball check valve illustrated in FIG. 10 (at the time of injection of high-pressure water).

As illustrated in FIG. 10 and FIG. 11, the control rod drive mechanism in this example has a configuration using a disc spring as the ball support mechanism 17 instead of using the coil spring of the ball support mechanism 17 as in the CRD in Example 1. The control rod drive mechanism in this example is also applied to the BWR.

Note that the configuration other than the above configuration is substantially the same as that of the control rod drive mechanism in Example 1 described above, and therefore detailed description thereof is omitted.

Also in the CRD in this example, the disc spring used as the ball support mechanism 17 can change the portion where the ball 15 is brought into contact with the ball support mechanism 17 when high-pressure water is supplied and the spring is compressed. This makes it possible to reduce the risk of adhesion between the ball 15 and the upper portion of the ball support mechanism 17.

Because the disc spring is used as the ball support mechanism 17, the risk of adhesion between the ball 15 and the upper portion of the ball support mechanism 17 can be reduced with a simple configuration.

### Example 7

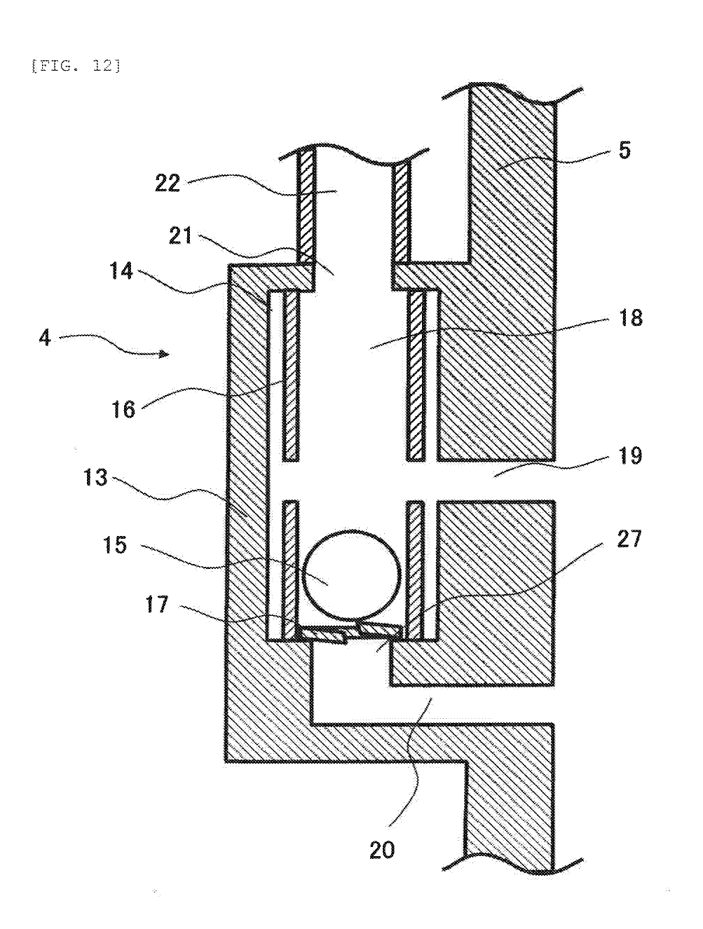

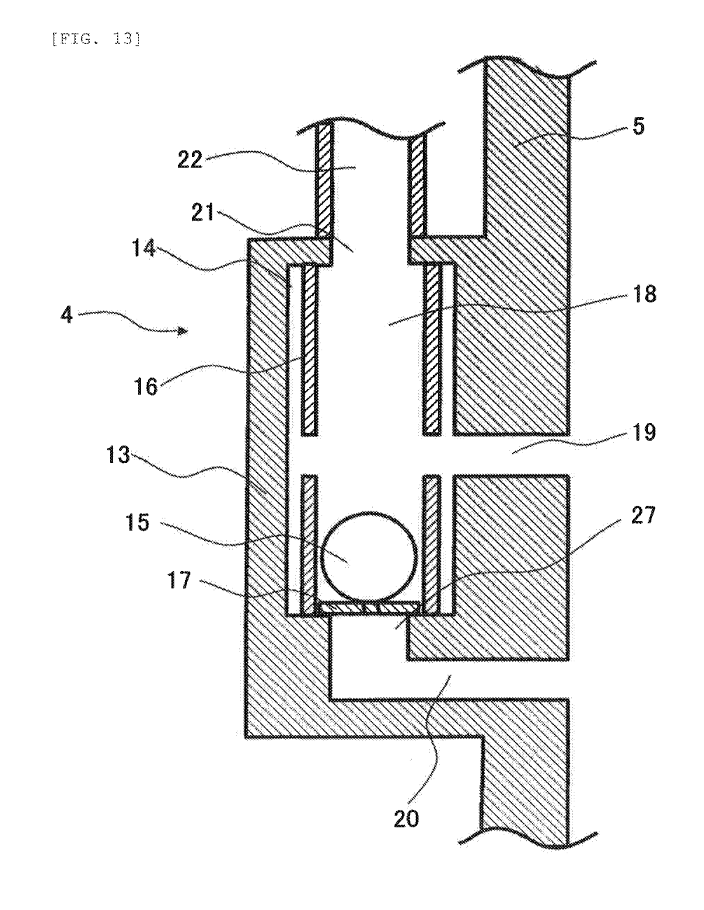

Example 7 of the control rod drive mechanism in the invention will be described with reference to FIG. 12 and FIG. 13. FIG. 12 is an enlarged view of a ball check valve of the control rod drive mechanism in Example 7 of the invention (at the time of injection of purge water). FIG. 13 is an enlarged view of the ball check valve illustrated in FIG. 12 (at the time of injection of high-pressure water).

As illustrated in FIG. 12 and FIG. 13, the control rod drive mechanism in this example has a configuration using a spring washer as the ball support mechanism 17 instead of using the coil spring of the ball support mechanism 17 as in the CRD in Example 1. The control rod drive mechanism in this example is also applied to the BWR.

Note that the configuration other than the above configuration is substantially the same as that of the control rod drive mechanism in Example 1 described above, and therefore detailed description thereof is omitted.

Also in the CRD in this example, the spring washer used as the ball support mechanism 17 can change the portion where the ball 15 is brought into contact with the ball support mechanism 17 when high-pressure water is supplied and the spring is compressed. This makes it possible to reduce the risk of adhesion between the ball 15 and the upper portion of the ball support mechanism 17.

Because the spring washer is used as the ball support mechanism 17, the risk of adhesion between the ball 15 and the upper portion of the ball support mechanism 17 can be reduced with a simple configuration.

### Example 8

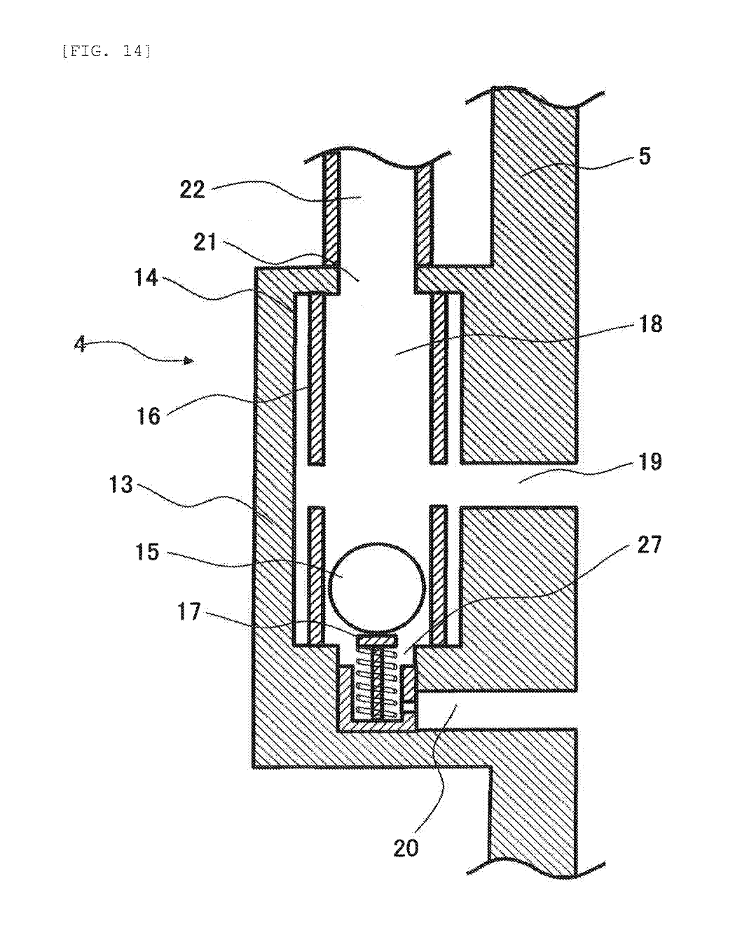

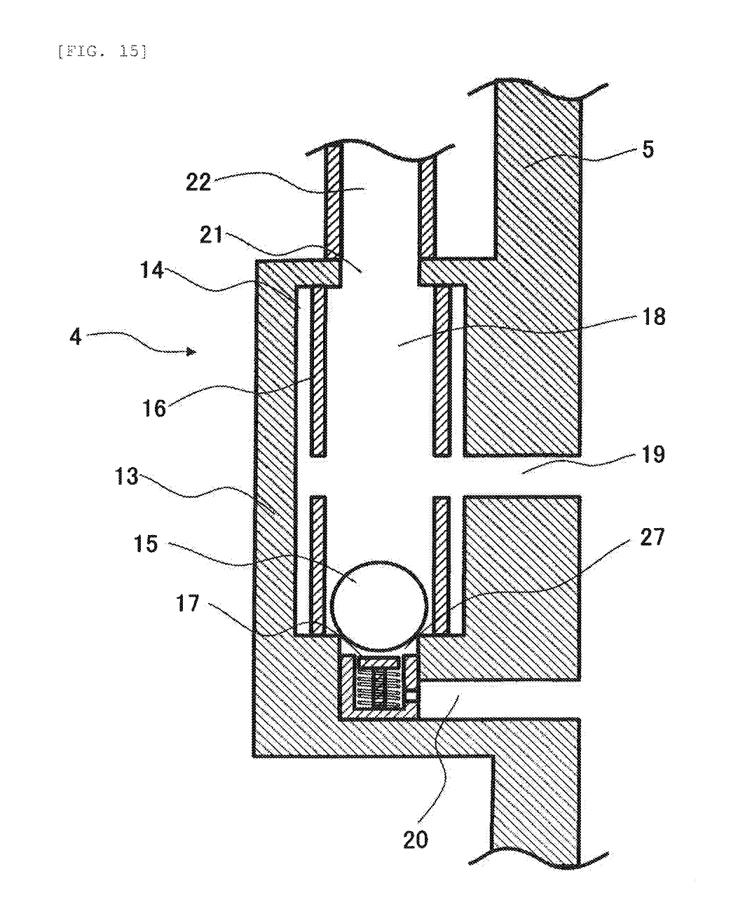

Example 8 of the control rod drive mechanism in the invention will be described with reference to FIG. 14 and FIG. 15. FIG. 14 is an enlarged view of a ball check valve of the control rod drive mechanism in Example 8 of the invention (at the time of injection of purge water). FIG. 15 is an enlarged view of the ball check valve illustrated in FIG. 14 (at the time of injection of high-pressure water).

As illustrated in FIG. 14 and FIG. 15, the control rod drive mechanism in this example has a configuration using, as a spring of the ball support mechanism 17, a coil spring whose spring constant is set so that, when the ball 15 is pressed to the lower opening portion 27 by a water pressure at the time of injection of high-pressure water, the upper end of the ball support mechanism 17 is apart from the lower end of the ball 15 by inertial force, instead of having the configuration in which the upper end portion of the ball support mechanism 17 has an inclined surface or a curved surface in the CRD in Example 1.

Note that the configuration other than the above configuration is substantially the same as that of the control rod drive mechanism in Example 1 described above, and therefore detailed description thereof is omitted.

Also in Example 8 of the control rod drive mechanism in the invention, it is possible to obtain an effect of reduction in the risk of adhesion between the ball 15 and the upper portion of the ball support mechanism 17, which is substantially the same effect as that of Example 1 of the control rod drive mechanism described above.

### <Others>

Note that the invention is not limited to the above examples and includes various modification examples. The above examples have been described in detail to easily understand the invention, and therefore the invention is not necessarily limited to the examples having all the configurations described above. Further, a part of a configuration of a certain example can also be replaced with a configuration of another example, and a configuration of another example can be added to a configuration of a certain example. Further, another configuration can be added to, removed from, or replaced with a part of the configuration of each example.

For example, examples where the invention is applied to the BWR as a reactor have been described. However, the invention is also applicable to other reactors such as ABWR.

### REFERENCE SIGNS LIST

1 . . . RPV,
2 . . . CRD housing,
3 . . . control rod,
4 . . . CRD (control rod drive mechanism),
5 . . . outer tube,
6 . . . guide tube,
7 . . . ball nut,
8 . . . ball spindle,
9 . . . hollow piston,
10 . . . motor unit,
11 . . . rotary shaft,
12 . . . spool piece,
13 . . . flange,
14 . . . ball check valve,
15 . . . ball,
16 . . . retainer,
17 . . . ball support mechanism,
18 . . . valve flow channel,
19 . . . central flow channel,
20 . . . lower flow channel,
21 . . . water introduction path,
22 . . . scram piping,
23A, 23B . . . flange,
24 . . . outer electromagnetic coupling,
25 . . . inner electromagnetic coupling,
26 . . . rotary shaft,
27 . . . lower opening portion,
28 . . . bolt.

1. A control rod drive mechanism, comprising:
a housing having a flange in a lower end portion;
a piston device for moving a control rod upward with a water pressure, the piston device being arranged in the housing;
a water introduction path for introducing high-pressure water to apply the water pressure to the piston device, the water introduction path being provided in the housing;
a ball check valve provided in the housing, communicating to an opening portion of the water introduction path, and including a ball for blocking the opening portion of the water introduction path when water in the housing flows backward to the water introduction path;
a central flow channel for introducing the high-pressure water into the housing, the central flow channel having an opening portion opened toward the ball check valve;
a lower flow channel having a lower opening portion opened toward the ball check valve at a position lower than a position of the opening portion of the central flow channel, the lower flow channel being a flow channel via which the water in the housing for pushing up the ball flows at the time of the backward flow; and
a drive-type ball support mechanism for supporting the ball, the drive-type ball support mechanism being provided in the flange, having a gap between the ball and a structural member forming the lower opening portion at the time of normal operation, and being deformed to change a contact state between the ball and the lower opening portion at the time of injection of high-pressure water.

2. The control rod drive mechanism according to claim 1, wherein
the drive-type ball support mechanism is a disc spring.

3. The control rod drive mechanism according to claim 1, wherein
an upper end portion of the ball support mechanism to be brought into contact with the ball has an inclined surface or a curved surface.

4. The control rod drive mechanism according to claim 1, wherein
the ball support mechanism arranges the ball at a position decentering from a center line of the lower opening portion at the time of normal operation.

5. The control rod drive mechanism according to claim 1, wherein
the center of the lower opening portion is arranged at a position decentering from the center of a retainer of the ball check valve.

6. The control rod drive mechanism according to claim 1, wherein
the drive-type ball support mechanism is a coil spring.

7. The control rod drive mechanism according to claim 1, wherein
the drive-type ball support mechanism is a torsion spring.

8. The control rod drive mechanism according to claim 1, wherein
the drive-type ball support mechanism is a plate spring.

9. The control rod drive mechanism according to claim 1, wherein
the drive-type ball support mechanism is a spring washer.

10. The control rod drive mechanism according to claim 1, wherein
the drive-type ball support mechanism is a spring and a spring constant of the spring is set so that an upper end portion of the spring is apart from a lower end of the ball when the ball is pressed to the lower opening portion at the time of injection of the high-pressure water.
